(19) United States
(12) Patent Application Publication
(10) Pub. No.: US 2026/0331992 A1
(43) Pub. Date: Oct. 22, 2026

(54) FIXATION OF CANNED TUBE

(71) Applicant: KLA Corporation, Milpitas, CA (US)

(72) Inventors: Flurin Dietz, Volketswil (CH); Philipp Jannik Weber, Volketswil (CH); Christian Loosli, Volketswil (CH)

(21) Appl. No.: 19/380,355

(22) Filed: Nov. 5, 2025

Related U.S. Application Data
(60) Provisional application No. 63/790,413, filed on Apr. 17, 2025.

(51) Int. Cl. H02K 5/124; F04D 25/06; F04D 29/056; F04D 29/10; H02K 7/08; H02K 15/144; H02K 21/14

(52) U.S. Cl. CPC H02K 5/124; F04D 25/0606; F04D 29/056; F04D 29/102; H02K 7/085; H02K 15/144; H02K 21/14

(57) ABSTRACT

A canned tube may seal a gasket to a housing by a spring clip and a disc spring. The fixation via the spring clip may be used for mounting the canned tube to the housing in an early mounting step and activates the sealing while the environment is clean. The fixation via the disc spring may press the canned tube to the housing in a final mounting step to compensate for the applied high pressure of a process gas.

### CROSS-REFERENCE

The present application claims the benefit under 35 U.S.C. § 119 of U.S. Provisional application 63/790,413, filed on Apr. 17, 2025, titled “FIXATION OF CANNED TUBE”, which is incorporated herein by reference in the entirety.

### TECHNICAL FIELD

The present disclosure generally relates to dynamo-electric machines, and, more particularly, to casings or enclosures which seal a shaft of the dynamo-electric machines.

### BACKGROUND

Compressors do not keep a clean gas path sealed when mounting a canned tube to a housing, as the canned tube is only pressed onto the housing in the final mounting step. Pressing the canned tube onto the housing, which requires cleaning after final mounting. Providing adequate cleaning to the clean gas path after final mounting is difficult. Therefore, it would be advantageous to provide a device, system, and method that cures the shortcomings described above.

### SUMMARY

A compressor is described, in accordance with one or more embodiments of the present disclosure. The compressor may include: a rotor, wherein the rotor includes an impeller, a rotor shaft, and a permanent magnet, wherein the impeller and the permanent magnet are affixed to opposing axial ends of the rotor shaft; a stator, wherein the permanent magnet is configured to magnetically couple with a magnetic field generated by the stator thereby driving rotation of the rotor; a housing, wherein the housing houses the rotor and the stator; a canned tube, wherein the permanent magnet is disposed radially inwards of and axially aligned with the stator and the canned tube, wherein the canned tube is disposed radially between the stator and the permanent magnet, a gasket; a spring clip; and a disc spring, wherein the housing, the canned tube, and the gasket fluidically seal the rotor from the stator, wherein the canned tube seals the gasket against the housing, wherein the spring clip and the disc spring each seal the canned tube against the gasket, wherein the spring clip and the disc spring are affixed to opposing axial ends of the canned tube and are affixed to the housing.

An inspection system is described, in accordance with one or more embodiments of the present disclosure. The inspection system may include: a compressor. The compressor may include: a rotor, wherein the rotor includes an impeller, a rotor shaft, and a permanent magnet, wherein the impeller and the permanent magnet are affixed to opposing axial ends of the rotor shaft; a stator, wherein the permanent magnet is configured to magnetically couple with a magnetic field generated by the stator thereby driving rotation of the rotor; a housing, wherein the housing houses the rotor and the stator; a canned tube, wherein the permanent magnet is disposed radially inwards of and axially aligned with the stator and the canned tube, wherein the canned tube is disposed radially between the stator and the permanent magnet, a gasket; a spring clip; and a disc spring, wherein the housing, the canned tube, and the gasket fluidically seal the rotor from the stator, wherein the canned tube seals the gasket against the housing, wherein the spring clip and the disc spring each seal the canned tube against the gasket, wherein the spring clip and the disc spring are affixed to opposing axial ends of the canned tube and are affixed to the housing.

A method of assembling a compressor, is described, in accordance with one or more embodiments of the present disclosure. The method may include: sealing a canned tube to a gasket by a spring clip; housing a rotor and a stator in a housing; and sealing the canned tube to the gasket by a disc spring.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a perspective view of a compressor with a partial cutaway through a compression section of a housing, in accordance with one or more embodiments of the present disclosure.

FIG. 1B depicts a section view of the compressor, in accordance with one or more embodiments of the present disclosure.

FIG. 1C depicts a partial view of the section view of the compressor illustrating the seal between a canned tube and a gasket by a spring clip and a disc spring, in accordance with one or more embodiments of the present disclosure.

FIG. 1D depicts a partial perspective view within the compressor of the canned tube sealing to the gasket by the spring clip, in accordance with one or more embodiments of the present disclosure.

FIG. 1E depicts a perspective view of the spring clip, in accordance with one or more embodiments of the present disclosure.

FIG. 2 depicts a block diagram of an inspection system including the compressor, in accordance with one or more embodiments of the present disclosure.

FIG. 3 depicts a flow diagram of a method of assembling the compressor, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to the fixation of a canned tube. The canned tube may seal a gasket to a housing by a spring clip and a disc spring. The fixation via the spring clip may be used for mounting the canned tube to the housing in an early mounting step and activates the sealing while the environment is clean. The fixation via the disc spring may press the canned tube to the housing in a final mounting step to compensate for the applied high pressure of a process gas.

U.S. Patent Number US11329529B2, titled “Electrical machine and rotor for an electrical machine”; U.S. Patent Number US11817760B2, titled “Electrical machine”; U.S. Patent Publication Number US20240297551A1, titled “Rotor for a high-speed electrical machine”; U.S. Patent Publication Number US20240356408A1, titled “Rotor for a high-speed electrical machine”; U.S. Patent Publication Number US20240377758A1, titled “Metrology of nanosheet surface roughness and profile”; European Patent Number EP4455499A1, titled “High speed electrical machine”; European Patent Number EP4456385A1, titled “High speed electrical machine”; are each incorporated herein by reference in the entirety.

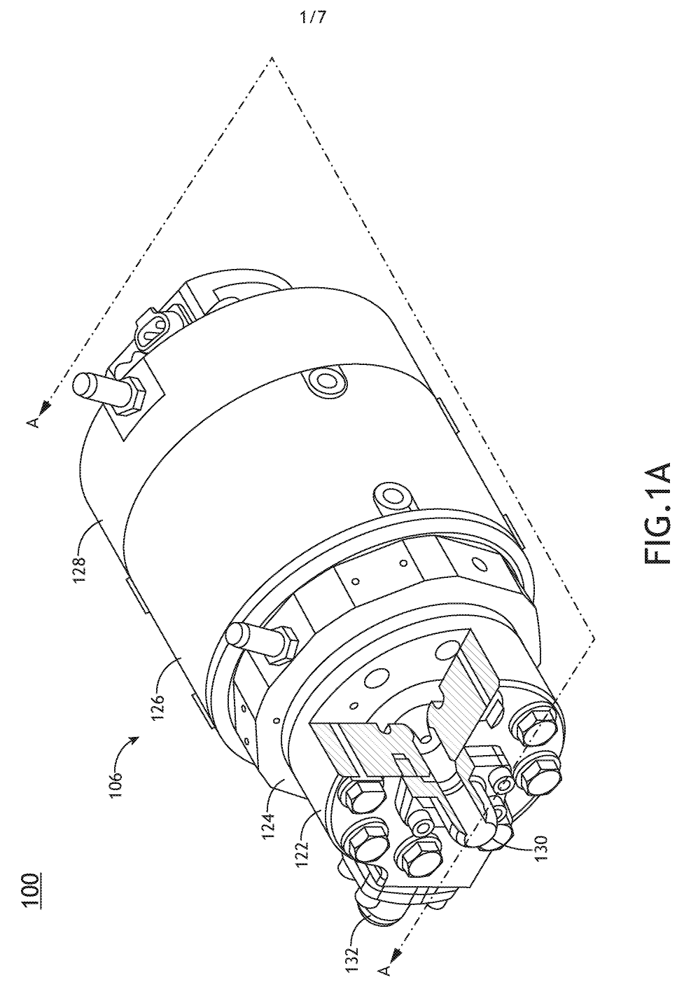

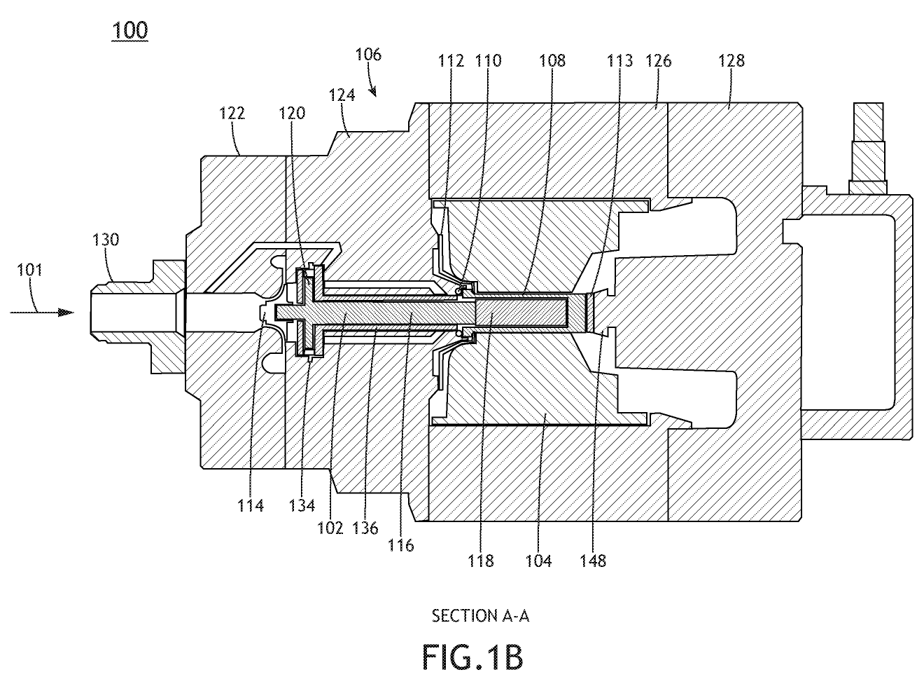

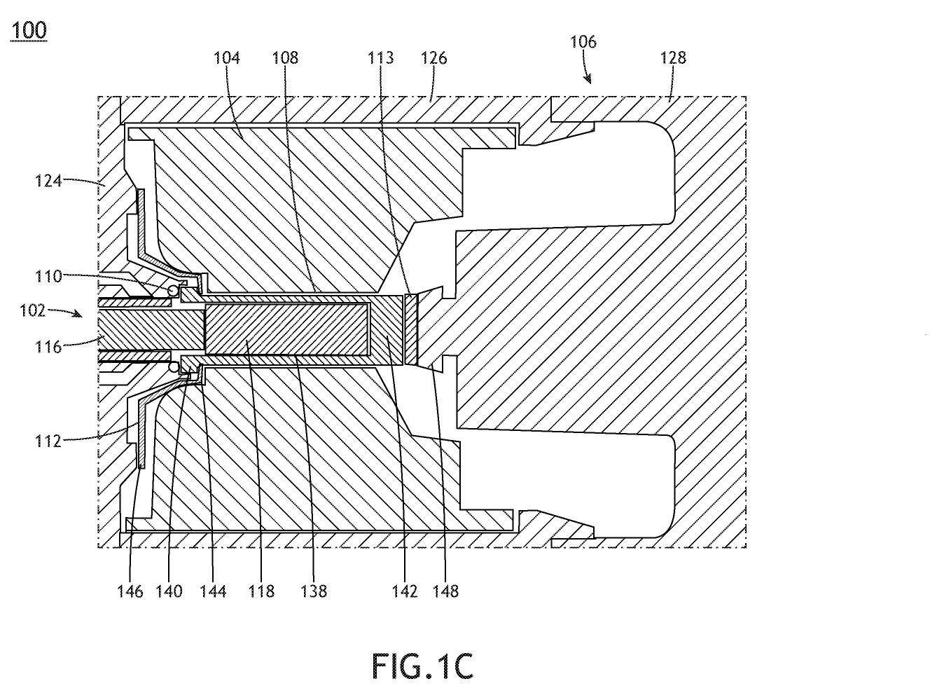

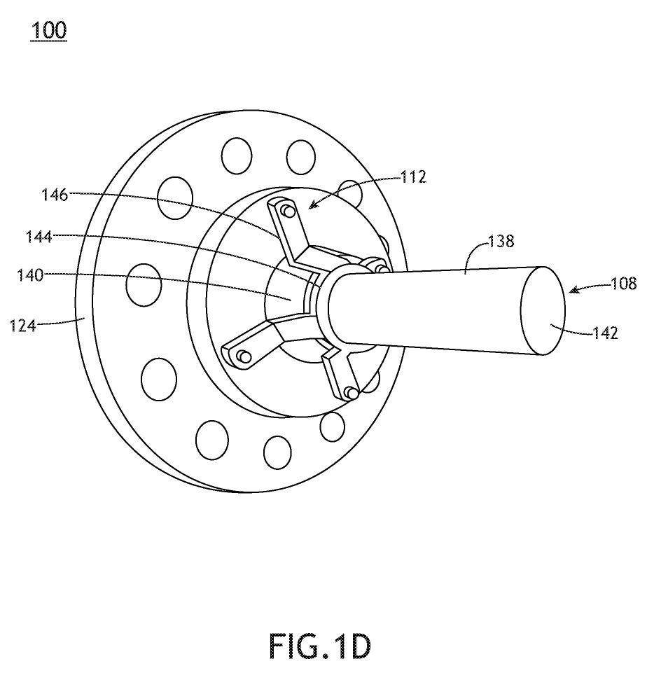

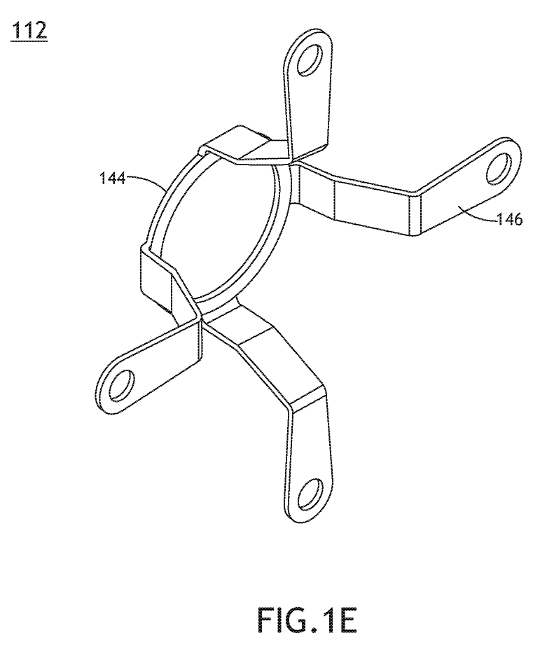

FIGS. 1A-1E depict a compressor 100, in accordance with one or more embodiments of the present disclosure. The compressor 100 may include a rotor 102, a stator 104, a housing 106, a canned tube 108, a gasket 110, a spring clip 112, a disc spring 113, an axial bearing 134, and/or a radial bearing 136. The rotor 102 may include one or more components, such as an impeller 114, a rotor shaft 116, permanent magnet 118, and/or a rotor disc 120.

The housing 106 may house the rotor 102, the stator 104, the canned tube 108, the gasket 110, the spring clip 112, the disc spring 113, the axial bearing 134, and/or the radial bearing 136. The housing 106 may include one or more sections. For example, the housing 106 may include a compression section 122, a bearing section 124, an electric-motor section 126, and/or a coolant section 128. The compression section 122 may house the impeller 114 of the rotor 102. The bearing section 124 may house the rotor shaft 116 and/or the rotor disc 120 of the rotor 102, the axial bearing 134, and/or the radial bearing 136. The electric-motor section 126 may house the permanent magnet 118 of the rotor 102, the stator 104, the canned tube 108, the gasket 110, the spring clip 112, and/or the disc spring 113. The compression section 122 may be disposed at a first axial end of the housing 106. The bearing section 124 may be axially disposed between and affixed to the compression section 122 and the electric-motor section 126. The electric-motor section 126 may be axially disposed between and affixed to the bearing section 124 and the coolant section 128. The coolant section 128 may be disposed at a second axial end of the housing 106. The coolant section 128 may be used for cooling the stator 104 and/or the rotor 102 via the canned tube 108 using a cooling medium. For example, the coolant section 128 may include a coolant sump which is fluidically coupled to the electric-motor section 126, for pumping the coolant around the stator 104 and the canned tube 108. The housing 106 may be made of one or more materials. For example, the housing 106 may be made of steel, aluminum, and/or alloys thereof. The sections of the housing 106 may be made of combinations of the steel and aluminum.

The stator 104 may include stator windings, potting, and the like. The stator 104 may be configured to generate a magnetic field in response to receiving current through the stator windings. The stator windings may include an alternating current input. The stator windings may be slot-less with air gap winding, may be slotted windings, or the like.

The rotor 102 and the stator 104 may be configured in an inner-rotor, outer-stator configuration. The permanent magnet 118 of the rotor 102 may be disposed radially inwards of and axially aligned with the stator 104 and/or the canned tube 108. The permanent magnet 118 may magnetically couple with the magnetic field generated by the stator 104 driving a rotation of the rotor 102 about a center axis of the rotor 102. A magnetization axis of the permanent magnet 118 may be perpendicular to the center axis of the rotor 102 for forming the magnetic coupling. The permanent magnet 118 may include one or more magnets which are axially mounted one after the other to form a single body (e.g. ring, disc, or cylinder). For example, the magnets may be mounted within a sleeve to form the permanent magnet 118.

The impeller 114, the rotor shaft 116, the permanent magnet 118, and/or the rotor disc 120 may be affixed together. The rotation of the rotor 102 form the permanent magnet 118 may cause each of the impeller 114, the rotor shaft 116, the permanent magnet 118, and/or the rotor disc 120 to rotate together with a same angular velocity. The impeller 114 and the rotor disc 120 may be affixed to a first axial end of the rotor shaft 116, while the permanent magnet 118 may be affixed to a second axial end of the rotor shaft 116 opposed to the first axial end. Thus, the impeller 114 and the permanent magnet 118 may be affixed to opposing axial ends of the rotor shaft 116. The impeller 114 and the permanent magnet 118 may axially extend from the rotor shaft 116. The rotor disc 120 may extend radially outwards from the rotor shaft 116.

The rotor 102 may be configured to rotate about the center axis relative to the stator 104, the housing 106, the gasket 110, the spring clip 112, and/or the disc spring 113. The axial bearing 134 and/or the radial bearing 136 may form a revolute joint about which the rotor 102 may rotate.

The rotor shaft 116 and/or the radial bearing 136 may be axially offset from the stator 104, the canned tube 108, and/or the permanent magnet 118. The radial bearing 136 may couple radial forces between the rotor 102 and the housing 106. The radial bearing 136 may couple to the bearing section 124 of the housing 106. The rotor shaft 116 may be disposed radially inwards of and axially aligned with the radial bearing 136. The rotor shaft 116 and the radial bearing 136 may form a radial journal bearing. Thus, the rotor 102 may be radially supported by the rotor shaft 116 which is axially between the impeller 114 and the permanent magnet 118. The radial bearing 136 may include any suitable radial bearing, such as, but not limited to, a plain radial bearing (e.g., a bushing), a roller radial bearing, a needle radial bearing, or the like.

The axial bearing 134 may couple axial forces between the rotor 102 and the housing 106. Opposing faces of the axial bearing 134 may be compressed and held in place between the compression section 122 and the bearing section 124. The rotor disc 120 may be held between and configured to rotate relative to the opposing faces of the axial bearing 134. The rotor disc 120 may also be referred to as a thrust plate. The rotor disc 120 may extend radially outwards from the rotor shaft 116. The rotor disc 120 may be disposed axially between the impeller 114 and the permanent magnet 118 on the rotor 102. The rotor disc 120 may be disposed axially adjacent to the impeller 114. The axial bearing 134 may also couple radial loads between the rotor 102 and the housing 106. The rotor disc 120 and the axial bearing 134 may form an axial journal bearing.

The impeller 114 may be disposed axially between the compression section 122 and the bearing section 124. The impeller 114 may include a rotating set of vanes (or blades).

The compressor 100 may be a centrifugal compressor. The housing 106 (e.g., the compression section 122 of the housing 106) may include a process-gas inlet 130 and/or a process-gas outlet 132. The compressor 100 may be configured to receive a process gas 101 via the process-gas inlet 130 and pump the process gas 101 from the process-gas outlet 132. An inlet pressure of the process gas 101 may be on the order of tens or hundreds of bar (e.g., on the order of thousands or tens of thousands of kPa). For example, the inlet pressure may be up to 300 bar. For instance, the inlet pressure may be between 20 and 200 bar. The impeller 114 may fluidically couple between the process-gas inlet 130 and the process-gas outlet 132. The impeller 114 may raise the velocity of the process gas 101 coming from process-gas inlet 130 as the impeller 114 is rotated about the center axis. The compression section 122 may define a diffuser (not depicted). The diffuser may be downstream of the impeller 114 (e.g., between the impeller 114 and the process-gas outlet 132. The diffuser may slow the velocity of the process gas 101 from the coming from process-gas inlet 130, thereby increasing the pressure. The compression section 122 may include a plenum (not depicted). The plenum may be downstream of the diffuser (e.g., between the diffuser and the process-gas outlet 132). The plenum may also be referred to as a volute or a scroll. The plenum may fluidically couple to the process-gas outlet 132. The compression section 122 may also be referred to as a spiral section, due to the diffuser and/or the plenum. The diffuser and/or the plenum may be defined axially between the compression section 122 and the bearing section 124.

The process gas 101 may be an inert gas such as argon, xenon, nitrogen, or the like. The compressor 100 may not contaminate the process gas 101 when compressing the process gas 101. A portion of the process gas 101 may flow along the rotor 102. For example, a process gas 101 may flow along the rotor shaft 116 within the bearing section 124 and/or along the permanent magnet 118 within the electric-motor section 126.

The housing 106, the canned tube 108, and the gasket 110 may fluidically seal the rotor 102 from the stator 104. The housing 106, the canned tube 108, and the gasket 110 may seal the process gas 101 to the rotor 102. The canned tube 108 may be as a casing or enclosure of the permanent magnet 118. The stator 104 and the permanent magnet 118 may be radially separated by a magnetic (air) gap through which passes the magnetic field driving the rotor 102. The canned tube 108 may be disposed radially between the stator 104 and the permanent magnet 118 within the magnetic gap. In this regard, the canned tube 108 may also be referred to as an air-gap sleeve. The canned tube 108 may fluidically seal the stator 104 from the rotor 102. The canned tube 108 may be made of a select material. The canned tube 108 may be made of a material which is electrically non-conductive, which allows the magnetic field generated by the rotor 102 to penetrate through to the permanent magnet 118, and/or includes sufficient stiffness to contain the process gas 101 within the bearing section 124 by withstanding inner pressure. For example, the canned tube 108 may be made of a ceramic material. For example, the ceramic material may include, Silicon Carbide, Silicon Nitride, Zirconia, Aluminum Nitride, or the like. Generally, electrical insulators or materials with low electrical conductivity such as ceramics, glass ceramics or technical glasses, plastics, composites, mineral materials, and the like may be used to avoid excessive eddy current losses caused by the magnetic field.

The canned tube 108 may seal the gasket 110 against the housing 106. For example, the canned tube 108 may seal the gasket 110 against the bearing section 124 of the housing 106. The gasket 110 may be an elastic seal. The gasket 110 may include any suitable gasket, such as, but not limited to, an O-ring gasket or the like.

The spring clip 112 and the disc spring 113 may each seal the canned tube 108 against the gasket 110. The canned tube 108 may exert an axial force on the gasket 110, sealing the canned tube 108 against the gasket 110. The axial force between the canned tube 108 and the gasket 110 may be a sum of an axial force exerted by the disc spring 113 on the canned tube 108 and an axial force exerted by the spring clip 112 on the canned tube 108. The axial forces may also be referred to as thrust forces. The axial force exerted by the disc spring 113 on the canned tube 108 may be at least one order of magnitude larger than the axial force exerted by the spring clip 112 on the canned tube 108. The spring clip 112 may be beneficial during assembly to maintain the seal with the gasket 110, thereby preventing the stator 104 from contaminating the rotor and/or the process gas 101, but may not provide a sufficiently large force to seal the canned tube 108 against the gasket 110 when the canned tube 108 is subject to the inlet pressure of the process gas 101. The disc spring 113 may provide a sufficiently large force to seal the canned tube 108 against the gasket 110 when the canned tube 108 is subject to the inlet pressure of the process gas 101.

The spring clip 112 and the disc spring 113 may each be affixed to the canned tube 108 and the housing 106. The spring clip 112 and the disc spring 113 may be affixed to opposing axial ends of the canned tube 108. A position at which the spring clip 112 affixes to the housing 106 may be axially aligned with and disposed radially outwards of the rotor shaft 116. For example, the spring clip 112 may affix to the bearing section 124 of the housing 106. A position at which the disc spring 113 affixes to the housing 106 may be axially offset from and radially aligned with the rotor 102 and the canned tube 108 (e.g., concentric to the center axis). For example, the disc spring 113 may affix to the coolant section 128 of the housing 106.

The canned tube 108 may define one or more sections. For example, the canned tube 108 may define a hollow-cylinder section 138, a flange section 140, and/or a capped section 142. The flange section 140 and the capped section 142 may be disposed at opposing axial ends of the hollow-cylinder section 138.

The hollow-cylinder section 138 may define a blind-hole from a first axial end of the canned tube 108 through an axial depth up to the capped section 142. The blind-hole may be concentric to the center axis. The canned tube 108 may hold the permanent magnet 118 and/or the process gas 101 within the hollow-cylinder section 138.

The flange section 140 may also be referred to as a shoulder section. The flange section 140 may be disposed at the first axial end of the canned tube 108. The flange section 140 may be an annular shape. The flange section 140 may extend radially outward from the hollow-cylinder section 138. The flange section 140 may abut the gasket 110 and/or the spring clip 112. The flange section 140 may be axially disposed between the gasket 110 and/or the spring clip 112. The spring clip 112 may radially and axially extend from the flange section 140 and affix to the housing 106 (e.g., to the bearing section 124 of the housing 106). The spring clip 112 may exert the axial force on the flange section 140 causing the spring clip 112 to seal the canned tube 108 against the gasket 110. The spring clip 112 may include an annular section 144 and leg sections 146. The annular section 144 may abut to the flange section 140 along a radial face of the annular section 144 and/or receive the hollow-cylinder section 138 within an inner diameter of the annular section 144. The leg sections 146 may extend radially outwards from the annular section 144 and affix to the bearing section 124 of the housing 106. The leg sections 146 may then exert the torsional force due to internal shear stress. As depicted, the spring clip 112 includes four of the leg sections 146 which are arranged in a polar array about the annular section 144 and affixed to the bearing section 124 by fasteners, although this is not intended to be limiting.

The capped section 142 may be disposed at the second axial end of the canned tube 108. The capped section 142 may be a disc shape. The capped section 142 extend radially inward from the hollow-cylinder section 138 up to the center axis. The capped section 142 may abut the disc spring 113. The disc spring 113 may exert the axial force on the capped section 142 causing the disc spring 113 to seal the canned tube 108 against the gasket 110. The disc spring 113 may abut between the capped section 142 and the housing 106. Opposing axial ends of the disc spring 113 may abut the capped section 142 and the coolant section 128 of the housing 106. For example, the coolant section 128 may include a backstop 148. The disc spring 113 may abut the backstop 148. The backstop 148 may be coaxial with the center axis of the rotor 102. The backstop 148 may be axially aligned with and disposed radially inwards of the electric-motor section 126. The backstop 148 may cause the disc spring 113 to exert the axial force on the canned tube 108, thereby sealing the canned tube 108 to the gasket 110. The disc spring 113 may also compensate for thermal expansion of the housing 106, while maintain the seal between the canned tube 108 and the gasket 110.

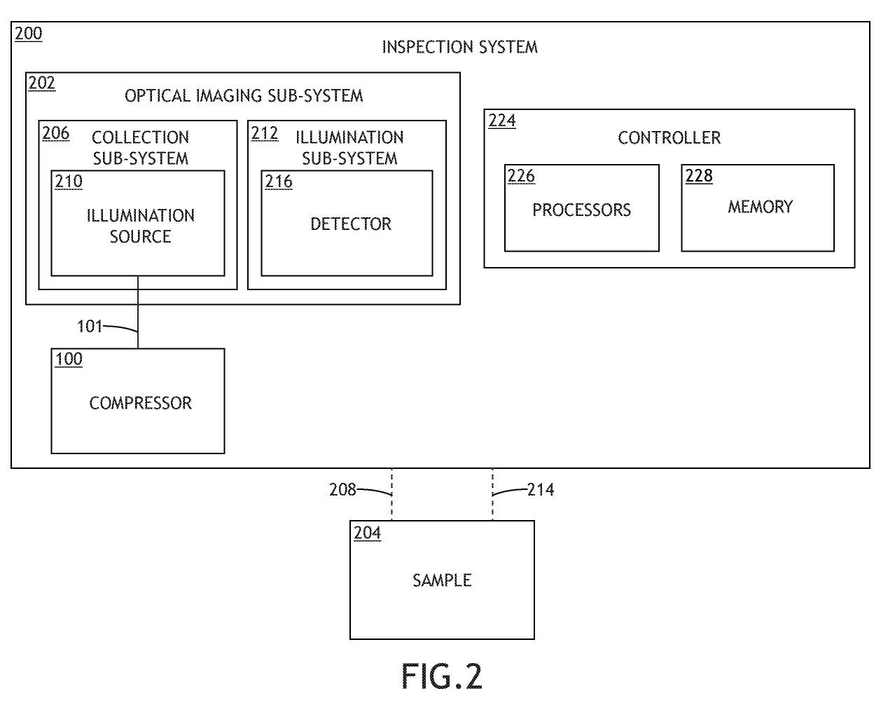

FIG. 2 depicts an inspection system 200, in accordance with one or more embodiments of the present disclosure. The inspection system 200 may include the compressor 100. In the field of semiconductor metrology, the inspection system 200 may include an optical imaging sub-system 202. The optical imaging sub-system 202 includes an illumination sub-system 206 which illuminates a target and a collection sub-system 212 which captures relevant information provided by the interaction (or lack thereof) of the illumination sub-system 206 with a target, device, or feature. The inspection system 200 also includes a controller 224 (e.g., a processing system) which analyzes the information collected using one or more algorithms.

The inspection system 200 may include any type of metrology system known in the art suitable for providing metrology signals associated with metrology targets on a sample. The optical imaging sub-system 202 can comprise one or more hardware configurations. For example, the optical imaging sub-system 202 may include, but is not limited to, a spectrometer, a spectroscopic ellipsometer with one or more angles of illumination, a spectroscopic ellipsometer for measuring Mueller matrix elements (e.g., using rotating compensators), a single-wavelength ellipsometer, an angle-resolved ellipsometer (e.g., a beam-profile ellipsometer), a spectroscopic reflectometer (e.g., broadband reflective spectrometer), a single-wavelength reflectometer, an angle-resolved reflectometer (e.g., a beam-profile reflectometer), a pupil imaging system, a spectral imaging system, or a scatterometer (e.g. speckle analyzer). The hardware configurations can be separated into discrete operational systems. On the other hand, one or more hardware configurations can be combined into the inspection system 200. For example, multiple metrology heads may be integrated in the inspection system 200.

In one embodiment, the inspection system 200 is configured to provide spectroscopic signals indicative of one or more optical properties of a metrology target (e.g., one or more dispersion parameters, and the like) at one or more wavelengths. In one embodiment, the inspection system 200 includes an image-based metrology tool to measure metrology data based on the generation of one or more images of a sample. In another embodiment, the inspection system 200 includes a scatterometry-based metrology system to measure metrology data based on the scattering (reflection, diffraction, diffuse scattering, and the like) of light from the sample.

In one embodiment, the inspection system 200 includes one or more of the optical imaging sub-system 202 (e.g., optical imaging tools). In some embodiments, the inspection system 200 may include a single of the optical imaging sub-system 202 or multiple of the optical imaging sub-system 202. Where the inspection system 200 is a spectroscopic imaging system, the multiple of the optical imaging sub-system 202 of the spectroscopic imaging system may include a broadband spectroscopic ellipsometer, a spectroscopic ellipsometer with rotating compensator, a beam profile ellipsometer, a beam profile reflectometer, a broadband reflective spectrometer, a deep ultra-violet reflective spectrometer, and the like. It is further contemplated that the optical imaging sub-system 202 include numerous optical elements in such systems, including certain lenses, collimators, mirrors, quarter-wave plates, polarizers, detectors, cameras, apertures, and/or light sources.

The one or more of the optical imaging sub-system 202 are configured to generate one or more images of a sample 204. For example, the optical imaging sub-system 202 may include an illumination sub-system 206 configured to illuminate the sample 204 with illumination 208 from an illumination sources 210 and a collection sub-system 212 configured to generate an image of the sample 204 in response to light emanating from the sample (e.g., sample light 214) the illumination 208 using a detector 216.

The illumination sub-system 206 includes illumination sources 210. Examples of suitable light sources are: a white light source, an ultraviolet (UV) laser, an arc lamp or an electrode-less lamp, a laser sustained plasma (LSP) source, a supercontinuum source (such as a broadband laser source), or shorter-wavelength sources such as x-ray sources, extreme UV sources, or some combination thereof.

The illumination sources 210 may generate illumination 208. The illumination 208 may have only one wavelength (i.e., monochromatic light), several discrete wavelengths (i.e., polychromatic light), multiple wavelengths (i.e., broadband light) and/or sweeps through wavelengths, either continuously or hopping between wavelengths (i.e., tunable sources or swept source). The illumination 208 may be polarization-resolved, unpolarized, or the like.

In embodiments, the illumination sources 210 may receive the process gas 101 from the compressor 100 and generate the illumination 208 using the process gas 101. For example, the illumination sources 210 may receive the process gas 101 from the process-gas outlet 132 of the compressor 100.

The illumination sources 210 may include any type of illumination source known in the art suitable for generating the illumination 208, which may be in the form of one or more illumination beams. Further, the illumination 208 may have any spectrum such as, but not limited to, extreme ultraviolet (EUV) wavelengths, ultraviolet (UV) wavelengths, visible wavelengths, or infrared (IR) wavelengths. Further, the illumination sources 210 may be a broadband source, a narrowband source, and/or a tunable source. In some embodiments, the illumination sources 210 includes a broadband plasma (BBP) illumination source. In this regard, the illumination 208 may include radiation emitted by a plasma. For example, the BBP illumination sources may include, but is not required to include, one or more pump sources (e.g., one or more lasers) configured to focus into the volume of the process gas 101, causing energy to be absorbed by the process gas 101 to generate or sustain a plasma suitable for emitting radiation. Further, at least a portion of the plasma radiation may be utilized as the illumination 208. In another embodiment, the illumination sources 210 may include one or more lasers. For instance, the illumination sources 210 may include any laser system known in the art capable of emitting radiation in the infrared, visible, or ultraviolet portions of the electromagnetic spectrum. The illumination 208 may have any temporal profile. For example, the illumination 208 may include continuous-wave (CW) illumination, pulsed illumination, or modulated illumination. Additionally, the illumination 208 may be delivered from the illumination sources 210 via free-space propagation or guided light (e.g., an optical fiber, a light pipe, or the like).

The illumination sub-system 206 and/or the optical imaging sub-system 202 may include various components to direct the illumination 208 to the sample 204 such as, but not limited to, lenses, mirrors, or the like. Further, such components may be reflective elements or transmissive elements. The illumination sub-system 206 may further include one or more optical elements to modify and/or condition light in the associated optical path such as, but not limited to, one or more polarizers, one or more filters, one or more beam splitters, one or more diffusers, one or more homogenizers, one or more apodizers, or one or more beam shapers. In embodiments, the illumination sub-system 206 and/or the optical imaging sub-system 202 includes a beam-splitter oriented to simultaneously direct the illumination 208 to the sample 204 and collect sample light 214 emanating from the sample 204. In this regard, the illumination 208 and the sample light 214 may share the same path between the beam-splitter and the sample 204.

The sample 204 may include a substrate formed of a semiconductor or non-semiconductor material (e.g., a wafer, or the like). For example, a semiconductor or non-semiconductor material may include, but is not limited to, monocrystalline silicon, gallium arsenide, and indium phosphide. The sample 204 may further include one or more layers disposed on the substrate. For example, such layers may include, but are not limited to, a resist, a dielectric material, a conductive material, and a semiconductive material. Many different types of such layers are known in the art, and the term sample as used herein is intended to encompass a sample on which all types of such layers may be formed. One or more layers formed on a sample may be patterned or un-patterned. For example, a sample may include a plurality of dies, each having repeatable patterned features. Formation and processing of such layers of material may ultimately result in completed devices. Many different types of devices may be formed on a sample, and the term sample as used herein is intended to encompass a sample on which any type of device known in the art is being fabricated.

The optical imaging sub-system 202 may include various components to collect at least a portion of the sample light 214 radiation emanating from the sample 204 (e.g., sample light in the case of an optical imaging sub-system 202) and direct at least a portion of the sample light 214 to a detector 216 for generation of an image. The collection sub-system 212 may further include any number of collection beam conditioning elements to direct and/or modify illumination collected including, but not limited to one or more lenses, one or more filters, one or more polarizers, or one or more phase plates. In this regard, the optical imaging sub-system 202 may be configured as any type of metrology tool such as, but not limited to, a spectroscopic ellipsometer with one or more angles of illumination, a spectroscopic ellipsometer for measuring Mueller matrix elements (e.g., using rotating compensators), a single-wavelength ellipsometer, an angle-resolved ellipsometer (e.g., a beam-profile ellipsometer), a spectroscopic reflectometer, a single-wavelength reflectometer, an angle-resolved reflectometer (e.g., a beam-profile reflectometer), an imaging system, a pupil imaging system, a spectral imaging system, or a scatterometer.

In another embodiment, the optical imaging sub-system 202 includes a detector 216 configured to capture radiation emanating from the sample 204 through the collection pathway. For example, a detector 216 may receive radiation reflected or scattered (e.g., via specular reflection, diffuse reflection, and the like) from the sample 204. By way of another example, a detector 216 may receive radiation generated by the sample 204 (e.g., luminescence associated with absorption of the illumination 208, and the like). By way of another example, a detector 216 may receive one or more diffracted orders of radiation from the sample 204 (e.g., 0-order diffraction, ±1 order diffraction, ±2 order diffraction, and the like). The detector 216 may include any type of sensor known in the art suitable for measuring sample light 214. For example, a detector 216 may include a multi-pixel sensor such as, but not limited to, a charge-couple device (CCD), a complementary metal-oxide-semiconductor (CMOS) device, a line sensor, or a time-delay-integration (TDI) sensor. As another example, a detector 216 may include two or more single-pixel sensors such as, but not limited to, a photodiode, an avalanche photodiode, a photomultiplier tube, or a single-photon detector. In some embodiments, the detector 216 may include the TDI sensor. The TDI sensor may include multiple pixel rows and a readout row. The TDI sensor may include clocking signals that successively move charge from one pixel row to the next until the charge reaches the readout row, where a row of the image is generated. By synchronizing the charge transfer (e.g., based on the clocking signals) to the motion of the sample along the scan direction, charge may continue to build up across the pixel rows to provide a relatively higher signal to noise ratio compared to a line sensor.

The optical imaging sub-system 202 may generate one or more images of the sample 204 using any technique known in the art. In some embodiments, the illumination sources 210 is an optical source configured to generate illumination 208 in the form of light, and where the collection sub-system 212 images the sample 204 based on light emanating from the sample 204. The inspection system 200 may further image the sample 204 using any technique known in the art. In some embodiments, the inspection system 200 generates an image of the sample 204 in a scanning mode by focusing the illumination 208 onto the sample 204 as a spot or a line, capturing a point or line image, and scanning the sample 204 to build up a two-dimensional image. In this configuration, scanning may be achieved by moving the sample 204 with respect to the illumination 208, by moving the illumination 208 with respect to the sample 204 (e.g., using actuatable mirrors, or the like), or a combination thereof. The scanning may include scanning the sample 204 along a scan path to generate a swath of the scan path. In some embodiments, the inspection system 200 generates an image of the sample 204 in a static mode by directing the illumination 208 to the sample 204 in a two-dimensional field of view and capturing a two-dimensional image directly with the detector 216.

An image generated by the inspection system 200 may be any type of image known in the art such as, but not limited to, a brightfield image, a darkfield image, a phase-contrast image, or the like. In some embodiments, the images may be raw images from the optical imaging sub-system 202. In this configuration, the inspection images may include various patterned features on the sample. Further, images may be stitched together to form a composite image of the sample 204 or a portion thereof, although this is not intended as a limitation of the present disclosure. Although the images have been described as including the patterned features, this is not intended as a limitation of the present disclosure. It is further contemplated that the images may be from a sample or wafer with no patterned features.

The optical imaging sub-system 202 may provide various types of measurements related to semiconductor manufacturing. For example, the optical imaging sub-system 202 may provide one or more metrology metrics of one or more metrology targets such as, but not limited to, a metrology metric. In this regard, the optical imaging sub-system 202 may also be referred to as a metrology tool. The metrology metric may include, but is not limited to, structural and material characteristics of the sample 204, bandgap, critical dimensions (e.g., widths of fabricated features at a selected height), overlay of two or more layers, sidewall angles, film thicknesses, or process-related parameters (e.g., focal position of a sample during a lithography step, an exposure dose of illumination during a lithography step, and the like). The structural characteristics of the sample 204 may include, but are not limited to, dimensional characteristics of structures and films such as film thickness and/or critical dimensions of structures, overlay, etc.) associated with various semiconductor fabrication processes. The material characteristics may include, but are not limited to, material composition associated with various semiconductor fabrication processes. The metrology metrics are used to facilitate process controls and/or yield efficiencies in the manufacture of semiconductor dies. It is recognized herein that semiconductor processes (e.g., deposition of a film, a lithography step, an etch step, and the like) performed by a semiconductor process tool may drift over time. Drift may be a result of a multitude of factors including, but not limited to, tool wear or drift in a control algorithm associated with the process. Further, the drift may affect one or more characteristics of a sample, which may, in turn, affect one or more metrology measurements (e.g., the metrology metric proportional to the bandgap, a critical dimension measurement, and the like). In this regard, metrology measurements may provide diagnostic information associated with one or more steps in a fabrication process. Metrology data may be utilized in the semiconductor manufacturing process for example to feed-forward, feed-backward and/or feed-sideways corrections to the process (e.g., a lithography step, an etch step, and the like) to provide a complete process-control solution.

In some embodiments, the inspection system 200 includes the controller 224. The optical imaging sub-system 202 is communicatively coupled to the controller 224. In this regard, the controller 224 may be configured to receive data including, but not limited to, metrology data (e.g., spectroscopic signals, images of the target, pupil images, and the like) or metrology metrics (e.g., a metrology metric proportional to a bandgap of a multilayer grating, critical dimensions, film thickness, composition, overlay precision, tool-induced shift, sensitivity, diffraction efficiency, through-focus slope, side wall angle, and the like). In some embodiments, the metrology data includes an indication of the measured spectral response (e.g., measured intensity as a function of wavelength) of the sample based on the one or more sampling processes from a spectrometer (e.g., the optical imaging sub-system 202).

The controller 224 may use the data from the optical imaging sub-system 202 in the semiconductor manufacturing process for example to feed-forward, feed-backward and/or feed-sideways corrections to the process (e.g., lithography, etch) and therefore, might yield a complete process control solution.

The controller 224 may include one or more processors 226 configured to execute program instructions maintained on a memory 228 (e.g., a memory medium). In this regard, the one or more processors 226 of controller 224 may execute any of the various process steps described throughout the present disclosure. The controller 224 may be communicatively coupled to the one or more optical imaging sub-system 202. The controller 224 may receive images from the optical imaging sub-system 202. For example, the controller 224 may receive the images from the detector 216.

The one or more processors 226 of a controller 224 may include any processing element known in the art. In this sense, the one or more processors 226 may include any microprocessor-type device configured to execute algorithms and/or instructions. In one embodiment, the one or more processors 226 may consist of a desktop computer, mainframe computer system, workstation, image computer, parallel processor, or any other computer system (e.g., networked computer) configured to execute a program configured to operate the inspection system 200, as described throughout the present disclosure. It is further recognized that the term “processor” may be broadly defined to encompass any device having one or more processing elements, which execute program instructions from a memory 228.

The memory 228 may include any storage medium known in the art suitable for storing program instructions executable by the one or more processors 226. For example, the memory 228 may include a non-transitory memory medium. By way of another example, the memory 228 may include, but is not limited to, a read-only memory, a random-access memory, a magnetic or optical memory device (e.g., disk), a magnetic tape, a solid-state drive, and the like. It is further noted that memory 228 may be housed in a common controller housing with the one or more processors 226. In one embodiment, the memory 228 may be located remotely with respect to the physical location of the one or more processors 226 and controller 224. For instance, the one or more processors 226 of controller 224 may access a remote memory (e.g., server), accessible through a network (e.g., internet, intranet, and the like). Therefore, the above description should not be interpreted as a limitation on the present invention but merely an illustration.

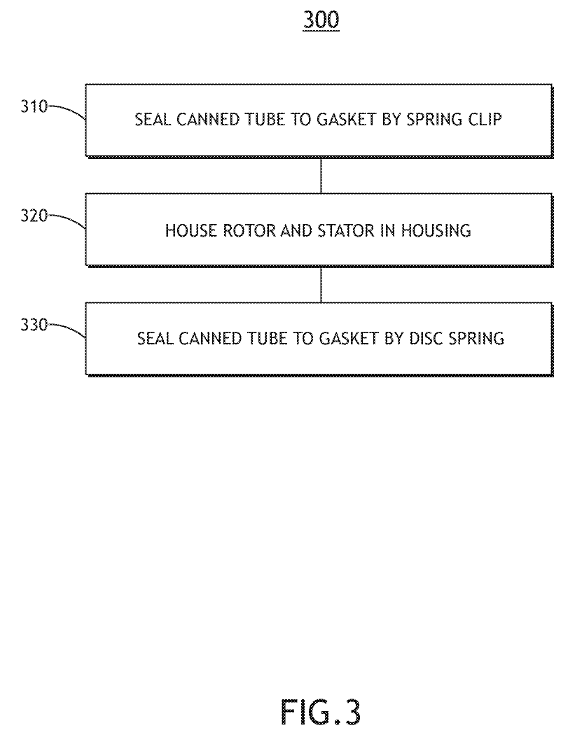

FIG. 3 depicts a flow diagram of a method 300, in accordance with one or more embodiments of the present disclosure. The method 300 may be a method of assembling the compressor 100. The embodiments and the enabling technologies described previously herein in the context of the compressor 100 should be interpreted to extend to the method 300. It is further noted, however, that the method 300 is not limited to the architecture of the compressor 100.

In a step 310, a canned tube may be sealed to a gasket by a spring clip. For example, the canned tube 108 may be sealed to the gasket 110 by the spring clip 112. The annular section of the spring clip 112 may be abutted to the flange section 140 and the leg sections 146 of the spring clip 112 may be affixed to the housing 106, thereby sealing the gasket 110. The spring clip 112 fixation may be used for mounting the canned tube 108 to the housing 106 in an early mounting step and activates the sealing while the environment is clean.

In a step 320, a rotor and a stator may be housed in the housing. For example, the rotor 102 and the stator 104 may be housed in the housing 106. The rotor 102 may be axially inserted from a first axial end of the bearing section 124 before the compression section 122 is affixed to the bearing section 124. The stator 104 may be axially inserted from a second axial end of the electric-motor section 126 of the housing 106 before the coolant section 128 is affixed to the electric-motor section 126. When assembling, the rotor 102 and the stator 104 are mounted after the canned tube 108. Sealing the gasket 110 by the spring clip 112 may be a pre-assembly process before the rotor 102 and the stator 104 are housed in the housing 106, to prevent contaminating the rotor 102 with the stator 104. The canned tube 108 may keep the potting of the stator 104 from contaminating the rotor 102.

In a step 330, the canned tube may be sealed to the gasket by a disc spring. For example, the canned tube 108 may be sealed to the gasket 110 by the disc spring 113. The disc spring 113 may compensate for the applied high pressure of the process gas 101 by pressing the canned tube 108 to the gasket 110. The disc spring 113 may be abutted between the canned tube 108 and the housing 106 by affixing the coolant section 128 of the housing 106 to the electric-motor section 126 of the housing 106. Thus, the method 300 may enable the compressor 100 to activate the seal between the canned tube 108 and the gasket 110 with the spring clip 112 while the environment is clean and compensate for the applied high pressure of the process gas 101 during operation with the disc spring 113.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "connected," or "coupled," to each other to achieve the desired functionality, and any two components capable of being so associated can also be viewed as being "couplable," to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A compressor comprising:
a rotor, wherein the rotor comprises an impeller, a rotor shaft, and a permanent magnet, wherein the impeller and the permanent magnet are affixed to opposing axial ends of the rotor shaft;
a stator, wherein the permanent magnet is configured to magnetically couple with a magnetic field generated by the stator thereby driving rotation of the rotor;
a housing, wherein the housing houses the rotor and the stator;
a canned tube, wherein the permanent magnet is disposed radially inwards of and axially aligned with the stator and the canned tube, wherein the canned tube is disposed radially between the stator and the permanent magnet,
a gasket;
a spring clip; and
a disc spring, wherein the housing, the canned tube, and the gasket fluidically seal the rotor from the stator, wherein the canned tube seals the gasket against the housing, wherein the spring clip and the disc spring each seal the canned tube against the gasket, wherein the spring clip and the disc spring are affixed to opposing axial ends of the canned tube and are affixed to the housing.

2. The compressor of claim 1, wherein a position at which the spring clip is affixed to the housing is axially aligned with and disposed radially outwards of the rotor shaft, wherein a position at which the disc spring is affixed to the housing is axially offset from and radially aligned with the rotor and the canned tube.

3. The compressor of claim 2, wherein the canned tube defines a hollow-cylinder section, a flange section, and a capped section, wherein the canned tube holds the permanent magnet within the hollow-cylinder section, wherein the flange section and the capped section are disposed at opposing axial ends of the hollow-cylinder section, wherein the flange section abuts the gasket and the spring clip, wherein the capped section abuts the disc spring.

4. The compressor of claim 3, wherein the spring clip comprises an annular section and one or more leg sections, wherein the annular section abuts to the flange section along a radial face of the annular section and receives the hollow-cylinder section within an inner diameter of the annular section, wherein the one or more leg sections extend radially outwards from the annular section and affix to the housing.

5. The compressor of claim 1, wherein the housing comprises a compression section, a bearing section, an electric-motor section, and a coolant section, wherein the bearing section is axially disposed between the compression section and the electric-motor section, wherein the electric-motor section is axially disposed between the compression section and the coolant section, wherein the compression section houses the impeller, wherein the bearing section houses the rotor shaft, wherein the electric-motor section houses the permanent magnet, the stator, the canned tube, the gasket, the spring clip, and the disc spring.

6. The compressor of claim 5, wherein the canned tube seals the gasket against the bearing section, wherein the spring clip is affixed to the bearing section, wherein the disc spring is affixed to the coolant section.

7. The compressor of claim 6, wherein the coolant section comprises a backstop, wherein the disc spring abuts the backstop, wherein the backstop is axially aligned with and disposed radially inwards of the electric-motor section.

8. The compressor of claim 1, wherein an axial force exerted by the disc spring on the canned tube is at least one order of magnitude larger than an axial force exerted by the spring clip on the canned tube.

9. The compressor of claim 1, wherein the compressor comprises a radial bearing, wherein the rotor shaft and the radial bearing are axially offset from the stator, the canned tube, and the permanent magnet, wherein the rotor shaft and the radial bearing form a radial journal bearing.

10. The compressor of claim 9, wherein the compressor comprises an axial bearing, wherein the rotor comprises a rotor disc, wherein the rotor disc extends radially outwards from the rotor shaft, wherein the impeller and the rotor disc are disposed at a first axial end of the rotor shaft, wherein the rotor disc and the axial bearing form an axial journal bearing.

11. The compressor of claim 1, wherein a magnetic field generated by the stator is configured to penetrate through the canned tube to the permanent magnet.

12. The compressor of claim 11, wherein the canned tube is a ceramic material.

13. The compressor of claim 1, wherein the gasket is an O-ring gasket.

14. The compressor of claim 1, wherein the housing comprises a process-gas inlet and a process-gas outlet, wherein the compressor is configured to receive a process gas via the process-gas inlet and pump the process gas from the process-gas outlet.

15. The compressor of claim 14, wherein an inlet pressure of the process gas is on an order of tens or hundreds of bar.

16. The compressor of claim 14, wherein a portion of the process gas is configured to flow along the stator.

17. An inspection system comprising:
a compressor, comprising:
a rotor, wherein the rotor comprises an impeller, a rotor shaft, and a permanent magnet, wherein the impeller and the permanent magnet are affixed to opposing axial ends of the rotor shaft;
a stator, wherein the permanent magnet is configured to magnetically couple with a magnetic field generated by the stator thereby driving rotation of the rotor;
a housing, wherein the housing houses the rotor and the stator;
a canned tube, wherein the permanent magnet is disposed radially inwards of and axially aligned with the stator and the canned tube, wherein the canned tube is disposed radially between the stator and the permanent magnet,
a gasket;
a spring clip; and
a disc spring, wherein the housing, the canned tube, and the gasket fluidically seal the rotor from the stator, wherein the canned tube seals the gasket against the housing, wherein the spring clip and the disc spring each seal the canned tube against the gasket, wherein the spring clip and the disc spring are affixed to opposing axial ends of the canned tube and are affixed to the housing.

18. The inspection system of claim 17, wherein the housing comprises a process-gas inlet and a process-gas outlet, wherein the compressor is configured to receive a process gas via the process-gas inlet and pump the process gas from the process-gas outlet.

19. The inspection system of claim 18, comprising an optical imaging sub-system, wherein the optical imaging sub-system comprises an illumination sub-system and a collection sub-system, wherein the illumination sub-system comprises an illumination source, wherein the illumination source is configured to receive the process gas from the compressor and generate illumination using the process gas.

20. A method of assembling a compressor, the method comprising:
sealing a canned tube to a gasket by a spring clip;
housing a rotor and a stator in a housing; and
sealing the canned tube to the gasket by a disc spring, wherein the compressor comprises:
the rotor, wherein the rotor comprises an impeller, a rotor shaft, and a permanent magnet, wherein the impeller and the permanent magnet are affixed to opposing axial ends of the rotor shaft;
the stator, wherein the permanent magnet is configured to magnetically couple with a magnetic field generated by the stator thereby driving rotation of the rotor;
the housing, wherein the housing houses the rotor and the stator;
the canned tube, wherein the permanent magnet is disposed radially inwards of and axially aligned with the stator and the canned tube, wherein the canned tube is disposed radially between the stator and the permanent magnet,
the gasket;
the spring clip; and
the disc spring, wherein the housing, the canned tube, and the gasket fluidically seal the rotor from the stator, wherein the canned tube seals the gasket against the housing, wherein the spring clip and the disc spring each seal the canned tube against the gasket, wherein the spring clip and the disc spring are affixed to opposing axial ends of the canned tube and are affixed to the housing.
